(19) United States
(12) Patent Application Publication
(10) Pub. No.: US 2005/0165821 A1
(43) Pub. Date: Jul. 28, 2005

(54) Method and system for delivering of messages

(75) Inventor: Kevin Leon Gest, Rottingdean (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/508,202

(22) PCT Filed: Feb. 17, 2003
(86) PCT No.: PCT/IB03/00591

(30) Foreign Application Priority Data
Mar. 23, 2002 (GB) 0206898.9

(51) Int. Cl. G06F 17/00

(52) U.S. Cl. 707/102

(57) ABSTRACT

A method, and infrastructure supporting the same, for enabling the supply of data to a predetermined group of recipients (14), each of which has a means (24) for displaying messages carried in said data and received electronically via a communications channel (28). A host (10) provides an electronic communications facility operating to send data to its own group of client recipients over the communications channel (28). A requesting party (12) provides to the host (10) one or more items of data and a plurality of individually specified recipient addresses, and the host (10) sends this data to each of the recipient addresses on behalf of the requesting party (12). In this arrangement, the host (10) can recoup some of the costs of establishing the communications facility by charging the requesting party (12) for message delivery, whilst the requesting party avoids such establishment costs.

The present invention relates to methods for selectively supplying data to specifically identified groups of recipients, and also to communications systems and devices supporting such methods.

Recent years have seen a huge increase in the volume of data that is being made generally available to the public, from a variety of sources. However, as this volume has increased, there has also been an increase in the need for means to specifically target the delivery of such data to avoid swamping recipients with large amounts of unnecessary material.

The internet has been a principal source of the increased volume of data, with many companies and organisations now using this as a primary means for communicating information to customers, members of staff and other interested parties. A number of problems arise with the targeting of information via the internet for such parties: firstly, the information provider is required to support a communications infrastructure that hosts a web site accessible by the target recipients; secondly, the target recipients are required to periodically log on to such a web site to see whether there is relevant information posted (including going through passwords and other access checks where the information is not intended for general public access) although this can be improved through the use of e-mail notifications to the intended recipients when relevant data is posted; thirdly, the recipients are required to have an internet access capability - typically through a personal computer or other web-enabled device. Such a system can therefore represent a large investment in terms of both cost and complexity for both the information provider and the target recipients.

An improved means for targeting recipients is through the use of an intranet, where access to the facility and the delivered information can be restricted to the intended recipients. An intranet infrastructure, particularly involving dedicated communications channels between the information provider and recipients, is typically an even more costly and complex set up than providing data through the internet.

It is an object of the present invention to provide a means for selectively making available data/information to a plurality of recipients whilst keeping equipment costs under control for those wishing to send data to targeted groups of recipients.

In accordance with the present invention there is provided a method for enabling the supply of data to a predetermined group of recipients, each of which has a means for displaying messages carried in said data and received electronically via a communications channel; wherein a host provides an electronic communications facility operating to send data to a first plurality of individually specified recipient addresses over one or more communications channels; wherein a requesting party provides to said host one or more items of data and a further plurality of individually specified recipient addresses; and wherein said host sends said one or more items of data to each of said recipient addresses.

With the host effectively making available spare capacity on an existing intranet to the requesting party, the capital costs to the requesting party are greatly reduced through not having to invest in their own communications infrastructure. The host may send the one or more items of data (representing targeted messages from the requesting party to their target recipients) in return for remuneration from the requesting party, thereby making it commercially attractive for the host to make available any spare capacity on their own intranet to recoup some of the costs from setting it up in the first place. The level of remuneration may be determined at least partly by the number of recipient addresses to which data is sent and/or the volume of data sent.

The host may format the data received from the requesting party prior to sending to said further plurality of recipient addresses, thereby relieving the requester of the need to fully author messages to be sent out. For improved efficiency, the host may store received groups of recipient addresses under a group alias, with the requesting party subsequently specifying those addresses by said group alias, to avoid the need to resend extensive address lists each time there is a new message.

The host typically has a finite capability in terms of the volume of data that can be handled, and suitably only that capability remaining after the handling of data for said first plurality of recipient addresses (the hosts own recipients) is made available to the requesting party. Where there are a number of requesting parties, this free capacity may be allocated according to priority of message, primacy of one party over another, or auctioned to the highest bidder.

The host may further send data of its own, (for example advertisements for its goods or services) to the specified recipients of the requesting party, and any business received as a result of such messages may be used to offset charges to the requesting party for the message delivery service.

Also in accordance with the present invention there is provided a data transmission system operable to support the method outlined above and comprising:
an address store holding individual connection addresses, over one or more communications channels, for a plurality of recipients;
a message data store arranged to receive from said requesting party and store one or more items of data for transmission;
data transmission means operable to transmit data from said message data store, via said one or more communications channels, to recipients whose individual connection addresses are held in said address store; and
control means arranged, on receipt of identification of a data item in said message data store and a plurality of recipients, to cause said data transmission means to transmit said identified data item to said recipients.

The invention further provides a communications system comprising the above data transmission system, together with said one or more communications channels, and a plurality of recipient receivers, wherein each recipient receiver comprises connection means operable to receive data received via said one or more communications channels and a display device operable to display messages carried in the received data. In order to keep costs low for the intended recipients, the display device is suitably a television set, and the connection means is a set-top box or an interface circuit with said television set: this avoids the need for internet access capability.

In such a communications system, the said one or more communications channels may provide a return data path from a recipient to said data transmission system, with said data transmission system being configured to identify any data messages from a recipient of said requesting party and forward the same to said requesting party. These communications channels may include a telephone line and/or a two-way satellite link.

Preferred embodiments of the present invention will now be described, by way of example only, with reference to the accompanying drawings in which:

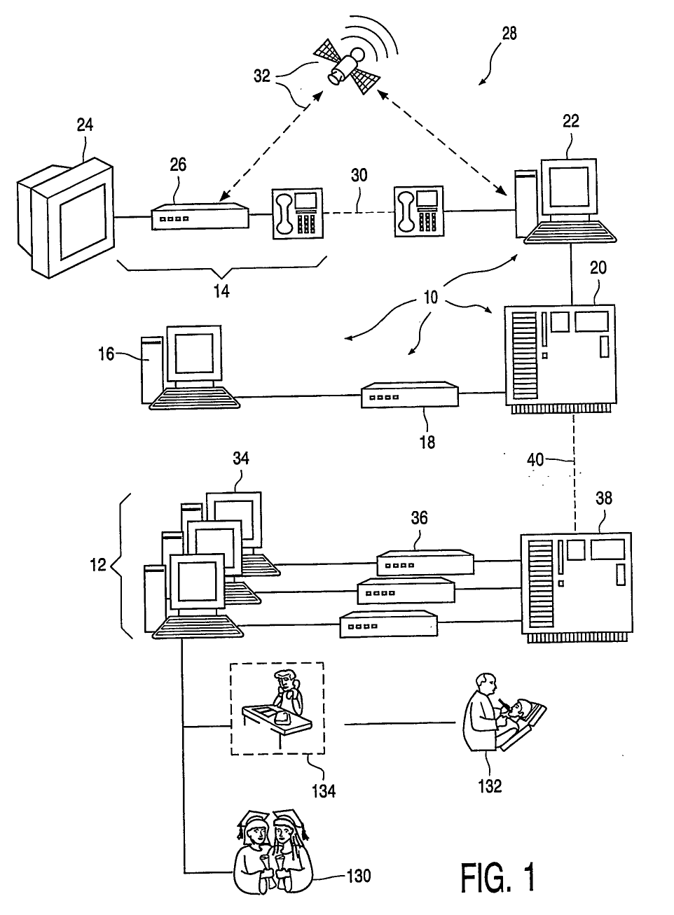

FIG. 1 is a general schematic view of a communications system embodying the present invention;

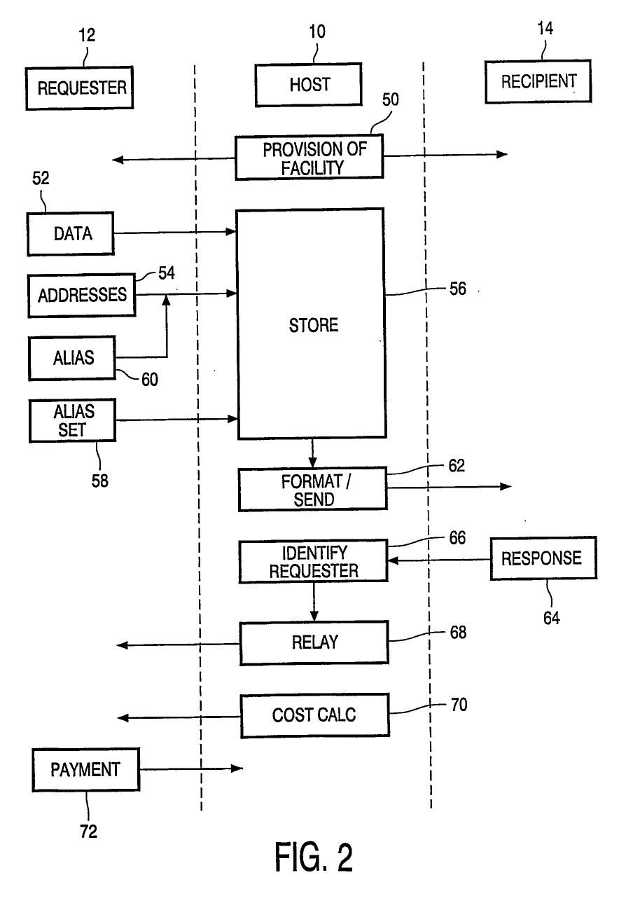

FIG. 2 schematically represents the provision of a message delivery service according to the present invention;

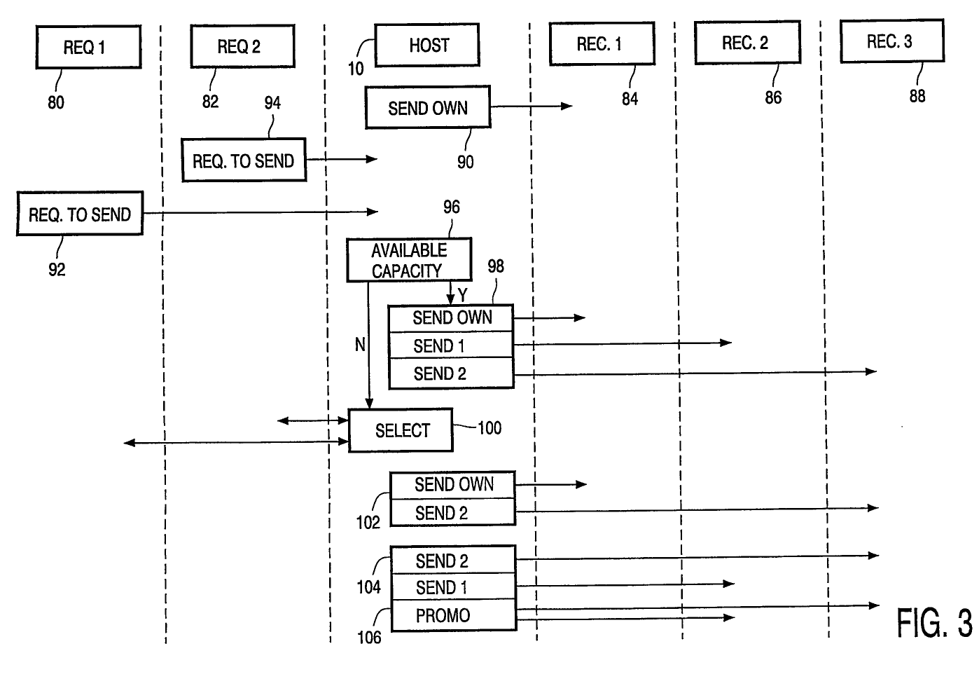

FIG. 3 represents a number of optional further features to the service of FIG. 2; and

Figure illustrates features of a data transmission system suitable to embody the present invention.

FIG. 1 generally illustrates a system by means of which a host 10 provides a virtual intranet by means of which one or more requesting third parties 12 are enabled to deliver messages to specifically targeted recipients 14 (only one shown for clarity). The host 10 will typically comprise one or a networked arrangement of computer terminals 16, each with a network connection 18 linking it to a central server 20. Also coupled with the server 20 is an output processor 22 which handles the addressing and delivery of messages to the remotely located recipients 14.

Recipients 14, whether clients or customers of the host 10 or of a requesting party 12, will have a means for receiving and displaying delivered messages. As shown, the recipient receiver may comprise a television set 24 of the user with message receipt and formatting for display being handled by a connected set-top box 26 or suitable interface card (not shown) incorporated within the television itself.

Linking the hosts output processor 22 and the set-top box (or card) 26 is a communications channel 28 which may, as shown, comprise a telephone link 30, a (preferably two-way) satellite link 32, a fibre optic link (not shown), or a combination of these.

In the embodiment illustrated, the requesting parties are shown as comprising a computer terminal 34 with communications connection 36 to a server 38, which server is connected (via link 40) to the hosts server 20. Such an arrangement simplifies the delivery of message,data from the requesting party 12 to host 10 but can represent quite an investment on the part of the requesting party, although the need for the requester to provide their own output processor (equivalent to device 22) is avoided. It will be appreciated, however, that the requesting party may not have such a message formatting and/or communications facility, and may instead communicate messages for delivery to the host in a variety of other ways, from electronic delivery of data down to verbal delivery in person or over a telephone line. With such basic forms of message delivery, the host may offer a message formatting service to put the received data into a message format agreed with the requester for delivery of their messages.

FIG. 2 represents the service provided by the host 10 linking a requester 12 with their target recipients 14, commencing generally with the provision of the service at 50.

The requesting party 12 provides to the host 10 one or more items of data 52 and a plurality of individually specified recipient addresses 54 to which the data is to be sent, and the host will store 56 the received information, either temporarily or for a longer period if the data delivery is to be deferred for some reason. To avoid the need for the requesting party to specify a long list of target addresses on repeat occasions, a facility is suitably provided whereby the requester and/or host applies an alias 58 for repeatedly used groups of recipients, such that on future occasions the requester need only specify 60 the alias for the group of recipients.

Having received the data for sending and the list of recipient addresses (or alias for a pre-stored list), the host formats the data and transmits it 62 to the target recipients.

As mentioned above, the communications channel or channels between host and recipient are preferably able to support two-way communication to support interaction by the recipient. As indicated at 64, where the recipient generates a response to a message or received data, the host receives that reply 66 and identifies the requester for which the replying recipient is a client and relays 68 the reply to that requester.

Having dispatched a message for a requester, the host calculates the cost 70 of the service and bills the requester, followed by remuneration 72 from the requesting party. As will be recognised, the level of remuneration may be determined at least partly by the number of recipient addresses to which data is sent, by the volume of data sent, or on some other basis. Additionally, billing for the service may be at intervals other than immediately after each message (for example weekly or monthly) and rather than purely financial remuneration, the requester may trade off the cost of the messaging service against goods or services which it is able to provide to the host.

FIG. 3 represents some possible additions or alterations to the service as described with reference to FIG. 2. In this instance there are two requesting parties 80, 82 wishing to send messages via the host 10, and three groups of recipients 84, 86, 88. The first group of recipients 84 are direct clients (customers, employees etc.) of the host itself, to which the host 10 is sending messages 90.

Where the host receives respective requests to send 92, 94 from the two requesting parties 80, 82, its first step will be to assess its capacity 96 and capability to handle the requested deliveries. If it has the capacity to handle all requested messages (including its own) then, as shown at 98 it will send out the respective messages to all three groups of recipients. If the capacity/capability assessment 96 shows there is insufficient capacity to handle both requesters messages in addition to its own, the host will perform a selection process 100 which may involve negotiation with the two requesters 80, 82 to identify the relative importance of their respective messages, to identify which might be prepared to pay a premium for faster delivery, or to decide in some other manner which requester message has primacy. Assuming the second requester 82 to have been successful, at 102 the messages of both the host 10 and the second requester 82 are sent. At 104, the situation occurs that the host 10 does not have messages to send to its clients 84 and instead it can utilise its capability to send the messages of both requesters 80, 82 together. As indicated at 106, the host 10 may add promotional material (such as advertisements for goods or services of the host) to the messages sent out to the clients of the requesters, with the requesters that agree to this being optionally given a discount for the cost of the messaging service.

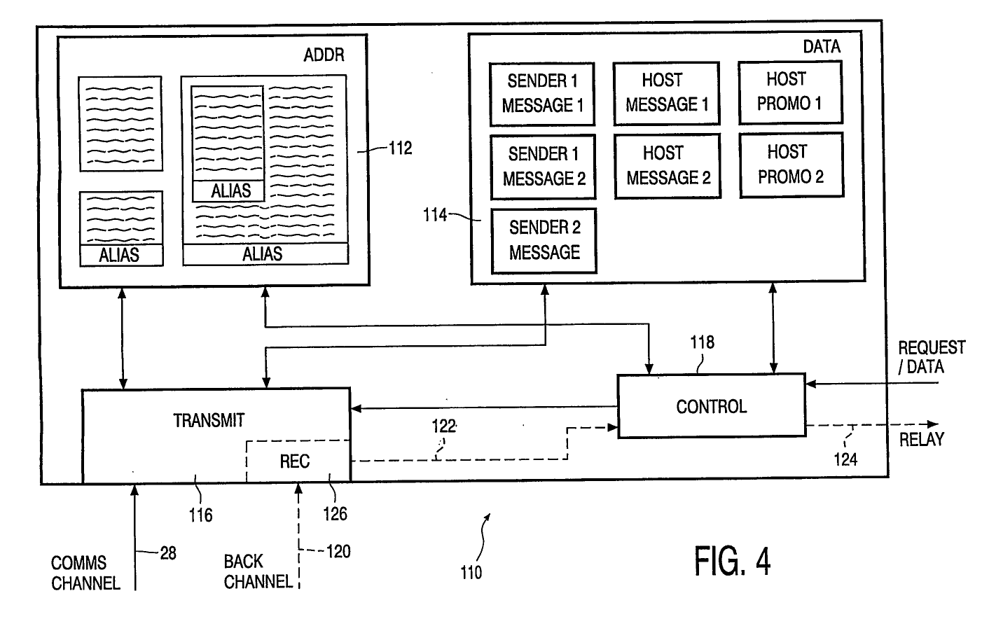

FIG. 4 illustrates features of the hosts data transmission system 110 operable to support the above-described message relaying method. The system comprises an address store 112 holding individual connection addresses, over one or more communications channels, for the plurality of recipients (both the hosts own clients and those recipient addresses notified by a requesting party). A message data store 114 is arranged to receive from requesting parties one or more items of data for transmission, as well as holding messages for transmission by the host to its own clients and promotional information to be passed on to other recipients (106; FIG. 3). A transmission stage 116 is operable to transmit data from the message data store 114, via said one or more communications channels (28; FIG. 1), to recipients whose individual connection addresses are held in the address store 112. As will be appreciated, the particular form of the transmission stage 116 will be dictated by the form of communication channel or channels over which the data is to be delivered.

Coupled with the stores 112, 114 and the transmission stage 116 is a processor or other control means 1 18 arranged, on receipt of identification of a data item in the message data store and a plurality of recipients, to cause the data transmission stage to transmit said identified data item to said recipients. As indicated by dashed lines 120, 122, 124, as described above the communications channel may comprise a two-way link with messages received 126 via such a back channel being passed via the control means 118 which identifies the requester whose client has responded prior to relaying 124 the message back to the requester.

The foregoing system enables connection of a television to a telephone line or other communications path, such as a two way satellite link, and enables information which is traditionally the domain of a corporate internet/intranet to be transmitted to and displayed on a television screen using an appropriate interface such as a Set Top Box (STB) or interface card within the television—an alternative (and cheaper) medium than the personal computer (PC). This would enable employees who do not have access to a PC as part of their working day, to receive the same information as those who do. It has global potential when used in conjunction with satellite broadcast. It is particularly suited for large manufacturing organisations, or those such as airlines. It is also suited for use by persons who have not been trained to use, or have the finance for, a PC. This might comprise:
Company communications such as in-house magazines (one way)
Maintenance of personal data such as records in an e-HR environment (interactive).
Selling of goods and services (interactive)
Email facility (two way).
Communication structure for the request and delivery of information.

In setting up, the host would typically establish the facility for its own use. It would then sell capacity and technical expertise to other organisations generating income from:
Initial costs that are chargeable
Revenue based on the number of employees connected and/or volume of data handled.
Revenue from the sales of the hosts services or products through the same channel to all company/3^{rd} party employees attached to the network.

If deployed on a wide scale it would enable other applications and information flows, such as:
Election voting
Market research
Access to National and local government information.
Distance learning (as represented at 130 in FIG. 1)
Banking
Communication with individuals who are “house bound”.
As an easy to use and low cost e-Medicine facility connecting persons in rural areas to consultants (132; FIG. 1) without the need to travel extensive distances (green medicine); or via a doctors surgery (134: FIG. 1) to a Hospital consultant.
Product Knowledge information learning for retail staff, etc.

Although defined principally in terms of a software-based or controlled implementation, the skilled reader will be well aware than many of the above-described functional features could equally well be implemented in hardware or a combination of software and hardware.

From reading the present disclosure, other modifications will be apparent to persons skilled in the art. Such modifications may involve other features which are already known in the design, manufacture and use of telecommunications systems and/or data network access apparatus and devices and component parts thereof and which may be used instead of or in addition to features already described herein.

1. A method for enabling the supply of data to a predetermined group of recipients, each of which has a means for displaying messages carried in said data and received electronically via a communications channel;
wherein a host provides an electronic communications facility operating to send data to a first plurality of individually specified recipient addresses over one or more communications channels;
wherein a requesting party provides to said host one or more items of data and a further plurality of individually specified recipient addresses; and
wherein said host sends said one or more items of data to each of said recipient addresses.

2. A method as claimed in claim 1, wherein said host stores received groups of recipient addresses under a group alias, and the requesting party subsequently specifies those addresses by said group alias.

3. A method as claimed in claim 1 or 2, wherein said host sends said one or more items of data in return for remuneration from said requesting party.

4. A method as claimed in claim 3, wherein the level of remuneration is determined at least partly by the number of recipient addresses to which data is sent.

5. A method as claimed in claim 3, wherein the level of remuneration is determined at least partly by the volume of data sent.

6. A method as claimed in any of claims 1 to 5, wherein the host formats the data received from said requesting party prior to sending to said further plurality of recipient addresses.

7. A method as claimed in claim 1, wherein the host has a finite capability in terms of the volume of data that can be handled, and only that capability remaining after the handling of data for said first plurality of recipient addresses is made available to said requesting party.

8. A method as claimed in any preceding claim, wherein the host further sends data of its own to the specified recipients of the requesting party.

9. A method as claimed in claim 8,.wherein the said data of its own sent by the host includes one or more advertisements for the host.

10. A data transmission system operable to support the method of claim 1, comprising:
an address store holding individual connection addresses, over one or more communications channels, for a plurality of recipients;
a message data store arranged to receive from said requesting party and store one or more items of data for transmission;
data transmission means operable to transmit data from said message data store, via said one or more communications channels, to recipients whose individual connection addresses are held in said address store; and
control means arranged, on receipt of identification of a data item in said message data store and a plurality of recipients, to cause said data transmission means to transmit said identified data item to said recipients.

11. A communications system comprising the data transmission system of claim 10, said one or more communications channels, and a plurality of recipient receivers, wherein each recipient receiver comprises connection means operable to receive data from said one or more communications channels and a display device operable to display messages carried in the received data.

12. A communications system as claimed in claim 11, wherein said display device is a television set.

13. A communications system as claimed in claim 12, wherein said connection means is a set-top box.

14. A communications system as claimed in claim 12, wherein said connection means is an interface circuit with said television set.

15. A communications system as claimed in any of claims 11 to 14, wherein said one or more communications channels provide a return data path from a recipient to said data transmission system, with said data transmission system being configured to identify any data messages from a recipient of said requesting party and forward the same to said requesting party.

16. A communications system as claimed in any of claims 11 to 15, wherein said one or more communications channels includes a telephone line.

17. A communications system as claimed in any of claims 11 to 15, wherein said one or more communications channels includes a two-way satellite link.
